(19) United States
(12) Patent Application Publication
(10) Pub. No.: US 2002/0077861 A1
(43) Pub. Date: Jun. 20, 2002

(54) Compact disk based medical information system

(76) Inventor: James K. Hogan, Rocky Point, NY (US)

Correspondence Address: WILLIAM COLLARD, COLLARD & ROE, P.C., 1077 NORTHERN BOULEVARD, ROSLYN, NY, 11576, US

(21) Appl. No.: 09/741,323

(22) Filed: Dec. 20, 2000

(51) Int. Cl. G06F 17/60

(52) U.S. Cl. 705/3; 705/2

(57) ABSTRACT

The invention relates to a medical information card that is in the form of a compact disk that has similar dimensions to a credit card. This compact disk is stored in a plastic sheath. An optional medical information sheet can be inserted into the plastic sheath adjacent to the medical information card so that a person inserting the medical information card into a computer will know whether a set of information stored on that card matches with a set of information stored on the sheet. Both the medical information card and the medical information sheet can have a digital picture of the user so that medical practitioners do not mix information relating to one user with information relating to another user. There is also a process for creating this medical information card. Essentially, the process includes the steps of presenting an application for a medical information card over a communication network, receiving medical and personal information from a user over that communication network, copying that information to a compact disk, and mailing the compact disk to the user. In a second embodiment of the process, the user can be presented with a paper-based application, wherein the user can then complete the application and then mail this application onto a receiving house where the information is eventually entered into a computer and then ultimately stored on a miniature compact disk.

### BACKGROUND OF THE INVENTION

1. Field of the Invention

The invention relates to a compact disk based medical information card containing the medical history of a user. More particularly, the invention relates to a compact disk having medical information stored thereon wherein this compact disk is shaped similar to a credit card.

According to experts, between 44,000 and 98,000 patients in U.S. Hospitals die from mistakes made by medical professionals. These mistakes or hospital errors makes this category the eighth leading cause of death ahead of traffic accidents, breast cancer and AIDS.

2. Description of the Prior Art

Thus, there would be a great benefit to a user to have a medical information card to present to a medical care provider in a hospital to cut down on hospital mistakes. Medical information cards are known in the art. For example, U.S. Pat. No. 6,021,393 to Honda et al. discloses a medical information management system using a portable memory card. The portable memory card stores the patient's medical data allowing his medical history to be readily available to treating physicians. The use of an optical card provides for storage of a large amount of information on a card that can fit into the patient's wallet.

U.S. Pat. Nos. 5,481,519 and 5,461,719 to Hosoya disclose a method for recording, reproducing and managing file data on a recording medium and a method for recording and reproducing information on a recording medium in accordance with parameters stored in memory to allow sectors of different data capacities to collectively exist.

U.S. Pat. No. 5,651,067 to Ahrens et al. discloses a storage and selective information transmission system for personal data.

U.S. Pat. No. 4,868,373 to Opheij et al. discloses a memory card comprising an optical memory disc and microelectronic memory component, and apparatus for transferring information to and from such card.

U.S. Pat. No. 4,996,681 to Cocco et al. discloses an integral card for protectively enclosing an optical disk and a visual information hearing area.

U.S. Pat. No. 5,923,018 to Kameda et al. discloses a medical care schedule and record aiding system, a medical care schedule and record aiding method, and a program storage device readable by the system. This patent discloses a database type program for managing medical records and information.

While the prior art has shown a medical information card having electronic medical information stored thereon, the prior art has not shown a medical information card that contains the picture of the individual along with the card. In addition, the prior art has not shown the use of a miniature compact disc shaped similar to a credit card for storing this medical information. Finally, the prior art has not shown using this miniature compact disk in combination with a plastic sheath and a personal information sheet having personal and medical information of the user printed thereon.

### SUMMARY OF THE INVENTION

One object of the invention is to provide a medical information card that is formed from a compact disk that can be read by a personal computer.

Another object of the invention is to provide a medical information card that is easy to read and easy for a user to carry.

Still another object of the invention is to present a medical information card to a user wherein this medical information card is stored in a plastic sheath along with a medical information sheet which can be used to further verify the medical history of the user.

These and other objects are achieved by creating a medical information card that contains medical information about a user. Disposed on a front face of this medical information card is a label that contains personal information and may optionally contain the user's photograph, or the user's social security number. This medical information card is essentially a miniature compact disk that has similar dimensions to a credit card. In addition, this medical information card can be inserted into a plastic sheath along with a medical information sheet containing information about the user.

There is also a system and a process for creating this medical card. The system comprises a computer network that contains a server connected to a general computer network such as the Internet or an intranet. Connected to this general computer network is a series of remote computers wherein the user logs into these remote computers and enters information into these remote computers and sends this information to the server. The server can then either download this information onto the medical card or download this information on a standard compact disk and ship that standard compact disk to a fulfillment house. The fulfillment house can also be used to create the medical card wherein the fulfillment house downloads information onto the medical card from the compact disk and then verifies this information. Finally, this medical card is placed inside the plastic sheath along with a medical information sheet and this package is shipped to the user.

In a second embodiment of the process according to the invention, users can also complete a paper-based application and then mail this application onto a receiving facility which either enters this information into the server or sends this information onto the fulfillment house where this information is organized and entered into a computer where it is then ultimately transferred to a miniature compact disk.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings wherein similar reference characters denote similar elements throughout the several views:

FIG. 1A shows a front view of the medical information card;

FIG. 1B shows a back view of the medical information card;

FIG. 2 shows a second embodiment of the medical information card;

FIG. 3 shows a computer network that can be used for carrying out a process for putting electronic medical information on the card;

FIG. 4 shows a simplified process for creating the medical information card over a computer network;

FIG. 5 shows a more complex process for creating the medical information card over a computer network;

FIG. 6 shows a first web page for receiving personal information relating to a user;

FIG. 7 shows a second web page for receiving medical information from a user;

FIG. 8 shows a third web page for receiving medical information from a user;

FIG. 9 shows a first application page for the second embodiment of the process;

FIG. 10 shows a second application page for the second embodiment of the process;

FIG. 11 shows a third application page for the second embodiment of the process; and

FIG. 12 shows fourth application page for the second embodiment of the process.

### DETAILED DESCRIPTION OF THE PREFERRED EMBODIMENT

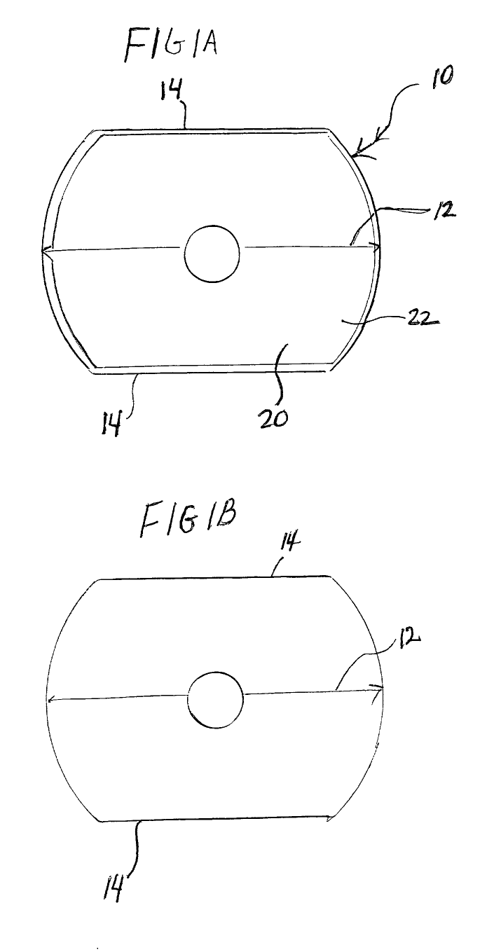

Referring in detail to the drawings, FIG. 1A shows a front side view of medical information card 10, which is shaped similar to a credit card. Medical information card 10 is essentially miniaturized compact disk that contains medical information. Card 10 has a smaller diameter 12 than a standard compact disk and flattened sides 14 to keep this disk in a substantially rectangular shape. Disposed on front face 20, of card 10, is a label 22 which contains personal identification information. This label is affixed to card 10 so that the information disposed on card 10 is not attributed to another user. This personal identification information can include the name, address and telephone number of the user, and optionally his or her social security number and a digitized photograph of the user. With this personal identification information, if a user is unconscious in a hospital, a medical professional can either match the photograph of the user on card 10 with the unconscious user, or match card 10 with the user by asking friends or associates of the user the user's name, address and telephone number.

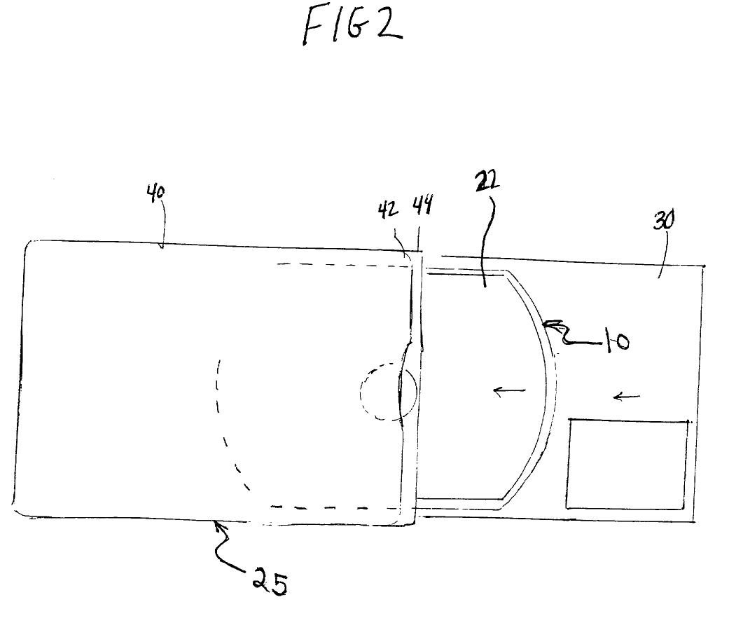

FIG. 2 shows a medical card package 25 comprising a medical card 10, having a label 22 fixed to a front face of card 10, and a medical information sheet 30 being inserted into a plastic sheath 40. Plastic sheath 40 contains a first flap 42 and a second flap 44 wherein card 10 and medical information sheet 30 are inserted between both flaps for protection. Once this medical card package 25 has been created, (see FIG. 2) it is shipped to a user.

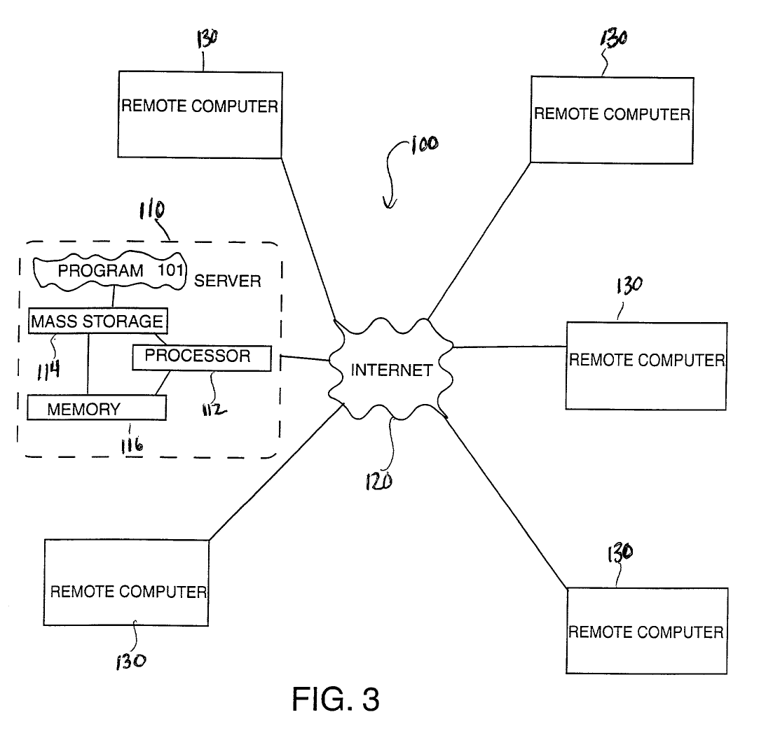

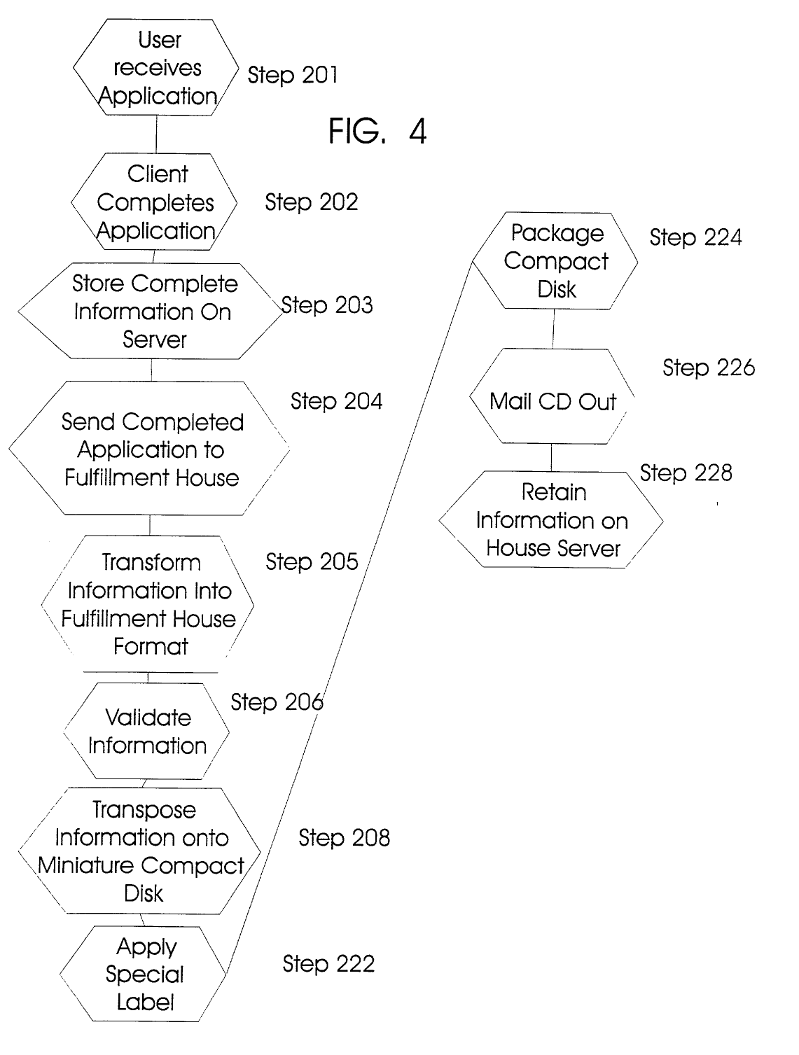

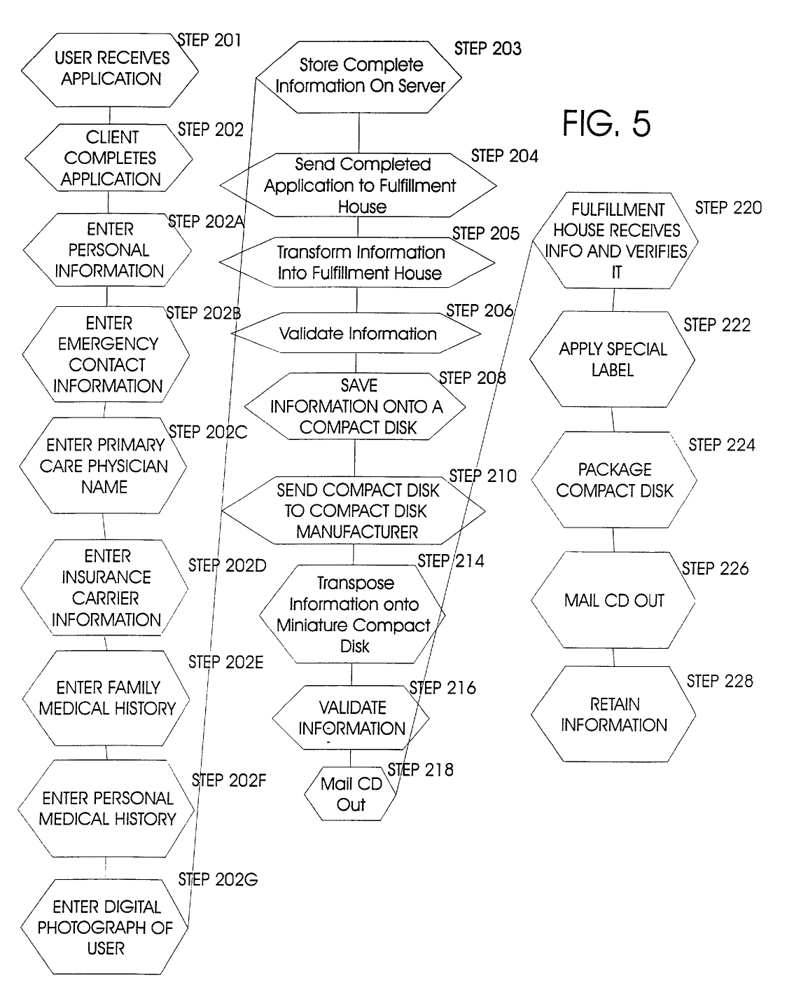

A computer network can be used to allow a user to enter information onto a server which is then used to create both medical information card 10 and medical information sheet 30. FIG. 3 shows a computer network 100 for performing the process for creating medical identification card 10. In this computer network 100 is a server 110 that comprises a processor 112, a mass storage 114 and a memory 116. Processor 112 could be formed from a processor manufactured by the Intel Corporation or Advanced Micro Devices Corporation (AMD) or any other type processor manufacturer. This processor 112 runs a program 101 that sets forth a series of steps shown in FIGS. 4 and 5.

Program 101 comprises a series of steps and provides instructions to processor 112 to perform a series of sequential or non sequential steps. Information generated or associated with program 101 can then be stored on mass storage 114, and then loaded into a resident memory 116. Both processor 112, the mass storage 114 and memory 116 are all interconnected so that all three components run together on server 110.

Program 101 can either be stored in mass storage 114, or imported to server 110 from another computer network 100. Server 110 is connected to a general computer network such as the Internet 120 which also connects to a series of remote computers 130. Computer network 100 could be associated with either the Internet 120 or the intranet system which includes either additional servers or additional remote computers. In this case, server 110 differs from remote computer 130 in that server 110 acts as a central store for communication between remote computers. Computer 130 is connected to computer network 100 on a client server basis wherein remote computer 130 is a client of server 110.

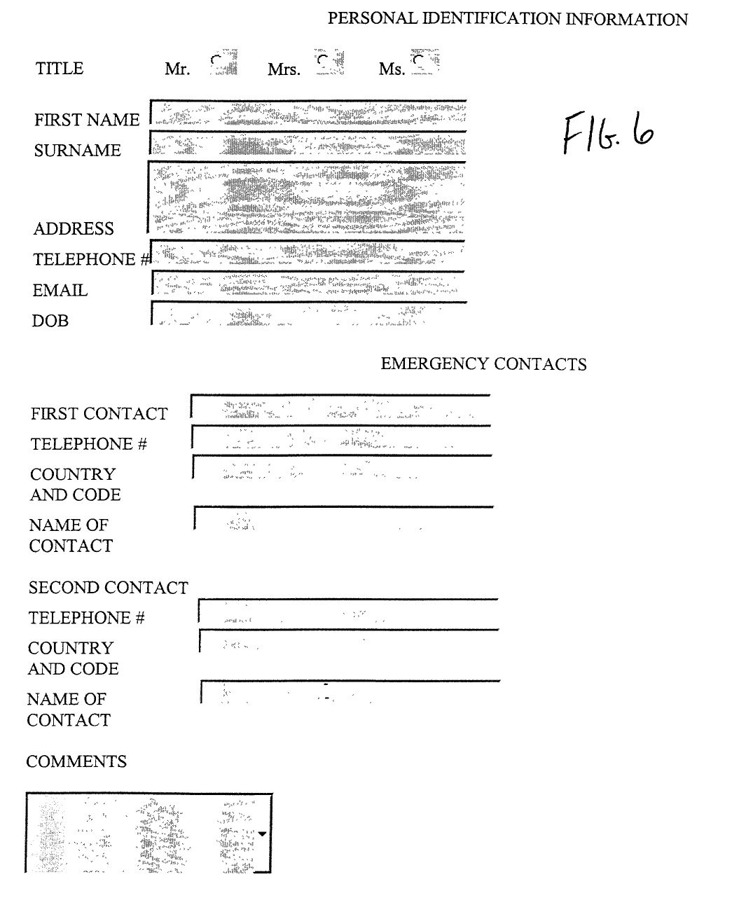

In this case, program 101 could be stored in mass storage 114 or imported into server 110 wherein it would load into memory 116. From memory 116, program 101 would then communicate with processor 112, such that processor 112 would perform a series of steps shown in FIGS. 4 and 5. In addition, there is also a series of web pages shown in FIGS. 6-8 wherein these web pages can either be stored in mass storage 114 or imported from another computer on computer network 100. These web pages contain a set of questions for gathering information or data that is either generated by program 101 or web pages that work along with program 101 to perform either a series of functions, or provide a series of solutions. The data associated with these web pages are loaded into memory 116 and then manipulated or altered by processor 112 to either create new sets of data tables or change the values of the data in an original set of tables, or simply remain the same data in those tables. Once program 101 is uploaded into processor 112, program 101 performs a series of steps as shown in FIGS. 4 and 5.

FIG. 4 shows a simplified process for creating the medical information card while FIG. 5 shows a more complex process for creating the medical information card. In this process, there is a series of steps starting with step 201 wherein a user receives an application for medical history over the computer network on a screen on remote computer 130. The user completes this application by inserting data into a series of fields shown in FIGS. 6, 7, and 8. More particularly, as shown in FIG. 5, step 202 comprises a series of sub steps wherein step 202A comprises entering personal identification information, step 202B comprises entering emergency contact information, step 202C comprises entering personal medical history information, step 202D comprises entering family medical history, step 202E comprises entering the user's primary care physician's name and contact information, step 202F comprises entering the name and identification information of the user's insurance carrier and step 202G comprises entering in a digital photograph of the user.

For example, in step 202A the user must enter his or her name, address, and phone number, but the user also has the option to enter in his or her email address, and his or her social security number. In step 202B the user would then enter the name, address and telephone number of an emergency contact person who should be reached if the user has been gravely injured as shown in FIG. 5.

In step 202C the user enters the name and telephone number of his or her primary care physician and can then optionally leave additional contact information for a backup primary care physician to call if the primary care physician listed cannot be reached. In addition, in step 202D the user enters in his or her medical insurance carrier information such as the name of the insurance carrier, the policy number and the group number.

In step 202E the user has the option to enter his or her family medical history such as whether the user's family has a history of heart attacks, cancer, diabetes, or any other type of heredity based disease.

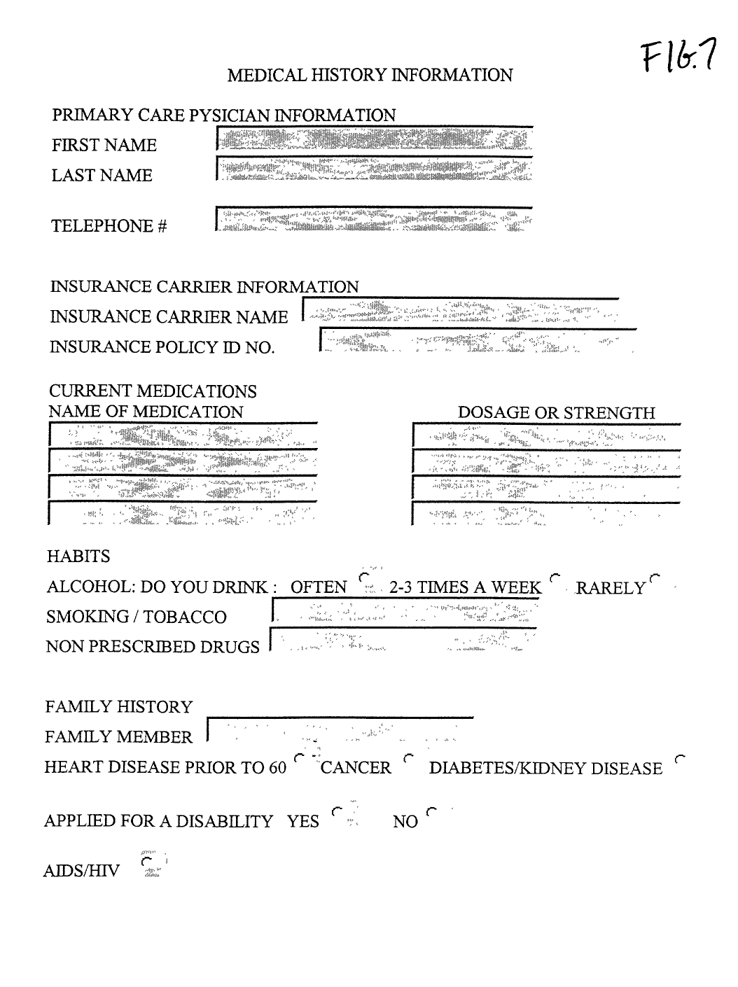

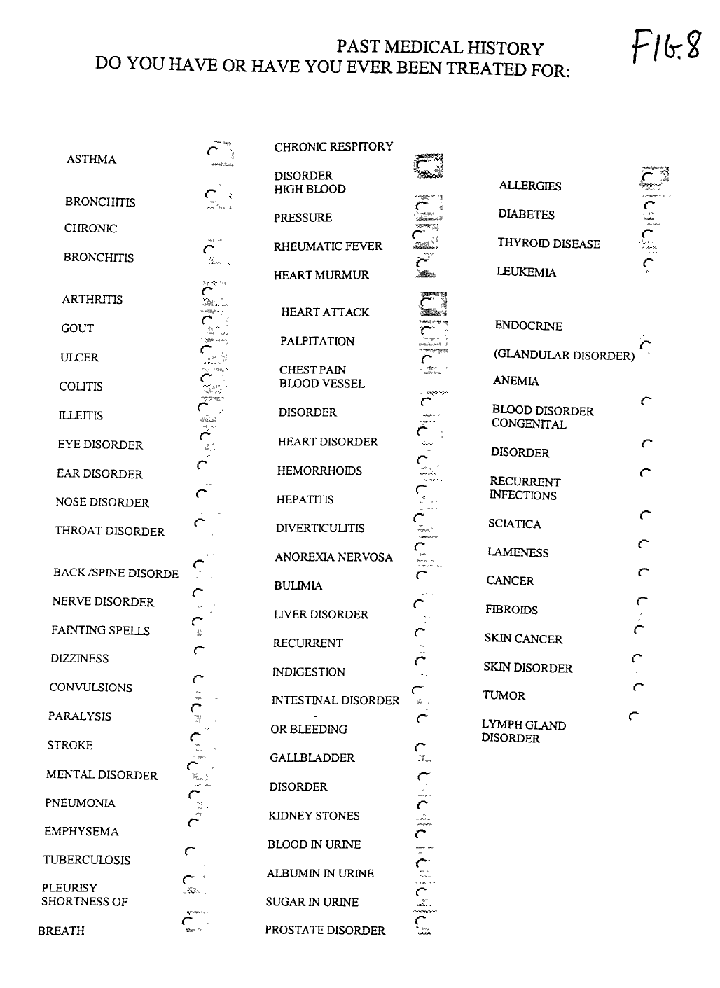

In step 202F the user has the option to enter in his or her habits, blood type, allergies, diagnostic testing history such as X-rays, MRIs, and blood tests, or history of medical treatments such as bronchitis, ulcer or sciatica as shown in FIGS. 7 and 8.

Finally, in step 202G the user can upload into the system or mail in a digital picture of the user so that this picture can be associated with this medical information. This picture could then be used to associate this background medical information with a particular patient and cut down on any mistakes associated with medical information or history applied to the wrong patient.

Once all of this information has been entered into remote computer 130 and transmitted to server 110, in step 203, this information is stored on server 110 and then, in step 204 sent to a fulfillment house. A fulfillment house is essentially a data input company that either inputs data or transforms data into a preset format. For example in step 205, this information is either transformed into a readable data file or keyed into a database wherein the information is stored as a data file that can be easily read by a personal computer. Next, in step 206, this information is validated so that an operator at the fulfillment house checks the information that was originally entered by the user in step 202 with the final data product created in step 205.

Next, if the fulfillment house cannot transcribe this information onto a miniature compact disk, in step 208, the fulfillment house transfers this information to a standard compact disk. Next, in step 210 the fulfillment house sends this information on a standard compact disk to a compact disk manufacturer. In step 214, the compact disk manufacturer then transposes this information onto a miniature compact disk and then in step 216 the compact disk manufacturer validates the information stored on the miniature compact disk with the information stored on the original compact disk.

Next, in step 218, the compact disk manufacturer mails this disk back to the fulfillment house. In step 220, the fulfillment house verifies this data and then the fulfillment house may in step 222, apply a special label to the miniature compact disk wherein this label includes personal identification information relating to that user. Next, in step 224, this compact disk is packaged with a medical information sheet and placed in a plastic sheath for mailing. In step 226, the medical information card including the compact disk, the medical information sheet and the plastic sheath are mailed with a letter thanking the user for purchasing the medical information card. Finally, in step 228 the information is retained on the server whereby this information can be updated by the user to produce an updated medical information card at a later date.

Now the user has a medical information card in the form of a compact disk that can be read by most personal computers. Because this information is stored on a miniaturized compact disk, shaped similar to a credit card, this information can be easily carried by users. In addition, since this information can be easily carried by users, and easily readable in a personal computer, it can also be readily available to medical professionals when a user is hurt or gravely injured and needs treatment. Thus, the user would benefit from this medical information card because this additional information would assist these medical professionals in treating the user which would most likely reduce the mortality rate in hospitals due to mistakes made in hospitals.

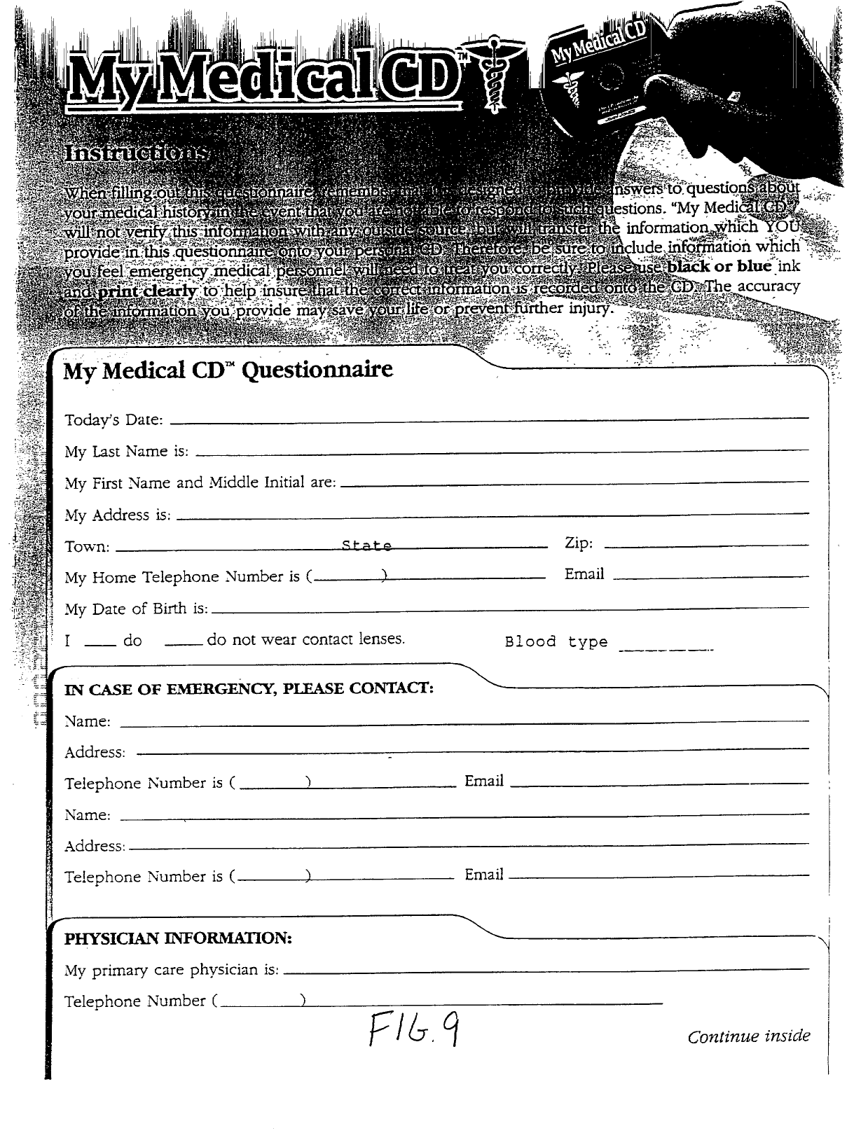

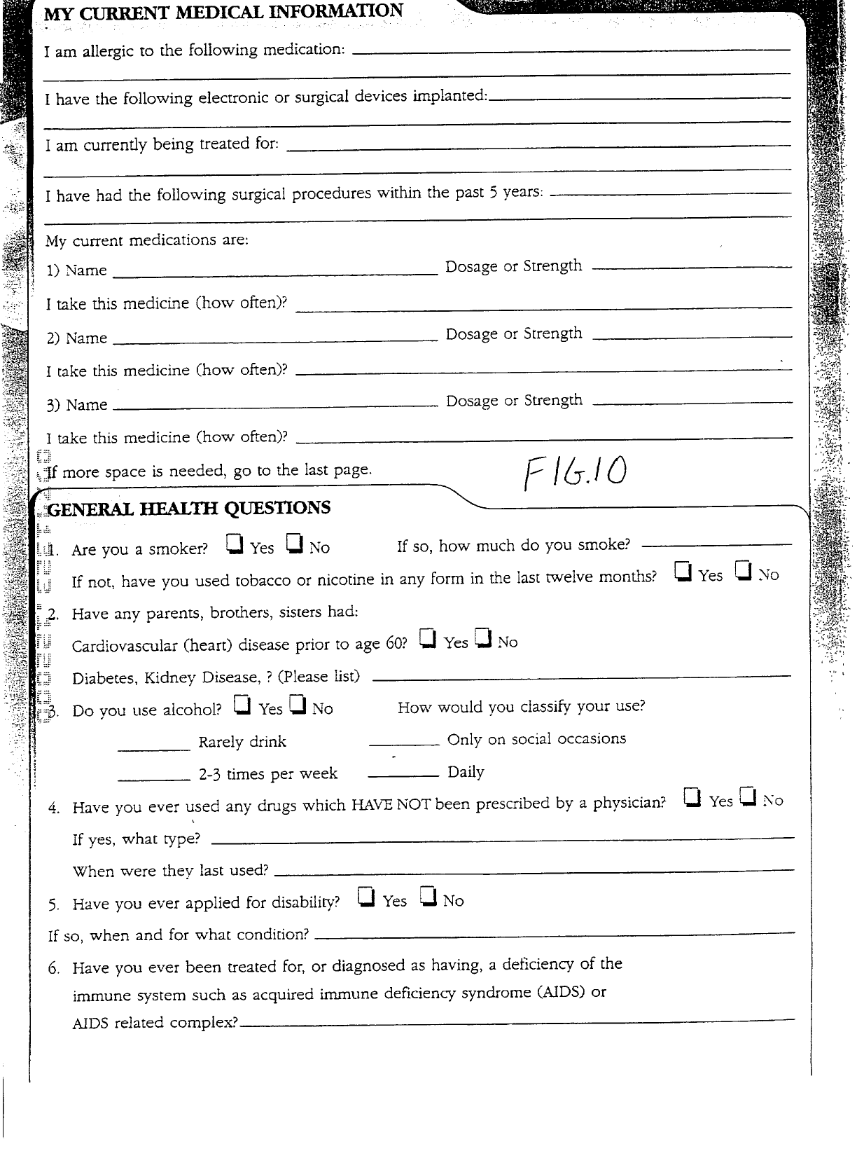

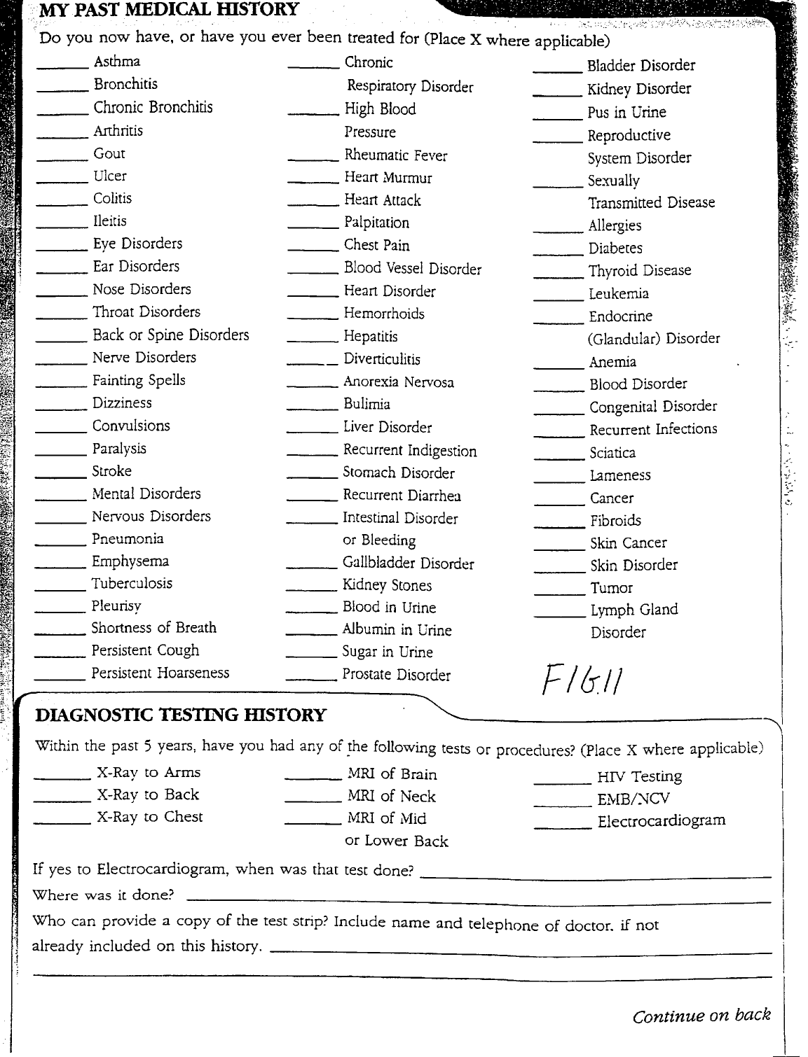

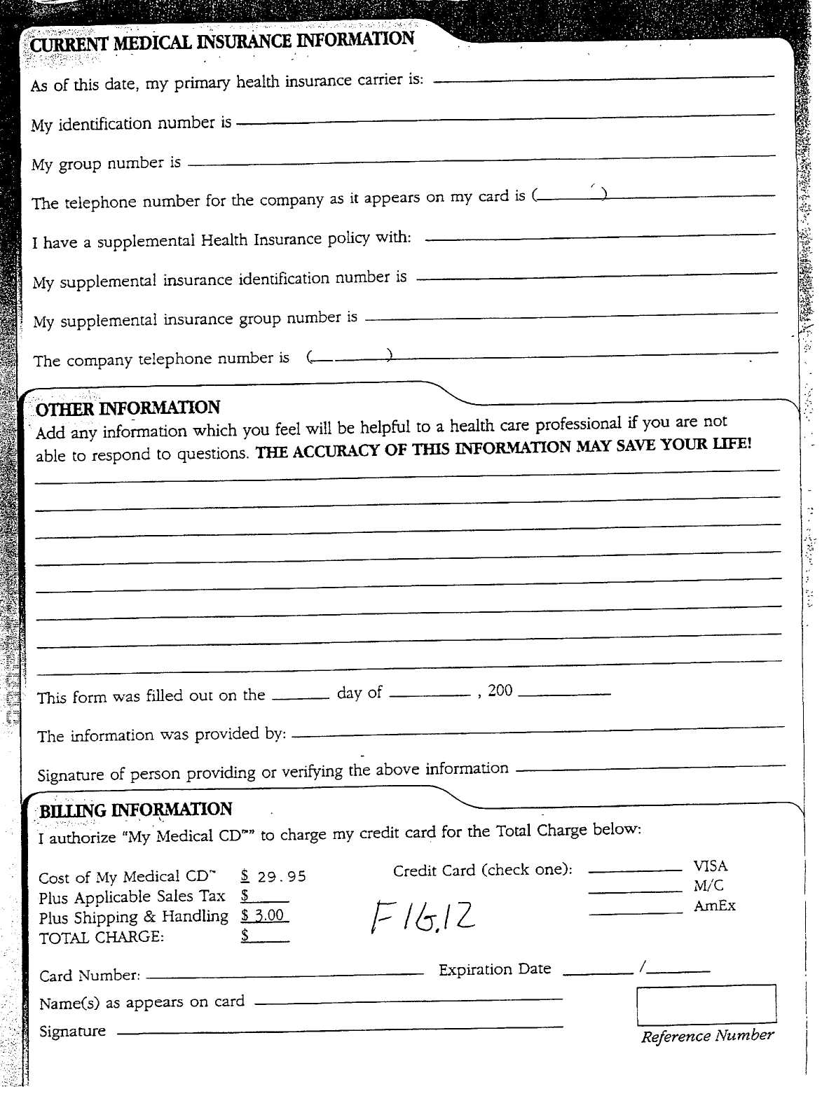

FIGS. 9, 10, 11 and 12 relate to the second embodiment of the process for creating medical card 10. FIGS. 9, 10, 11 and 12 show the first, second, third and fourth sheets of a paper-based application wherein a user can receive by mail, or any other means. Once the user answers the questions contained in the application thereby completing this application, the user then mails this application into a receiving facility which runs server 110. This receiving facility then has the option to enter this information into server 110 in step 203 and mail this information onto the fulfillment house in step 204, or simply skip step 203 and then mail this information to the fulfillment house where it is then keyed into a server at the fulfillment house. With this second embodiment of the invention, users can obtain a medical card without using a computer. While this information is eventually stored on a computer and a miniature compact disk, this second embodiment allows users who are not computer literate to participate in this program.

Accordingly, while several embodiments of the present invention have been shown and described, it is to be understood that many changes and modifications may be made thereunto without departing from the spirit and scope of the invention as defined in the appended claims.

What is claimed is:

1. A computer program product for use with a compact disk for a computer comprising:
computer readable medium in the form of a compact disk, having a computer readable program code comprising:
means for conveying personal identification information for a user;
means for conveying emergency contact information for a user; and
means for conveying primary care physician information for a user.

2. The computer program product as in claim 1, further comprising means for conveying a blood type for a user to the computer.

3. The computer program product as in claim 1, further comprising means for conveying information about said user's recent surgery history.

4. The computer program product as in claim 1, further comprising means for conveying information about said user's family medical history.

5. The computer program product as in claim 1, further comprising means for conveying a name of said user's medical insurance carrier and a set of contact information relating to said carrier.

6. The computer program product as in claim 1, further comprising means for conveying a picture of said user to said computer.

7. The computer program product as in claim 1, further comprising means for conveying a recent medical exam history for said user to said computer.

8. A medical information system comprising:
a non-circular shaped compact disk having a length and width that are substantially similar to a credit card;
a plastic sheath for covering said compact disk wherein said compact disk can be removed from said plastic sheath;
a computer readable program code disposed on said compact disk wherein said computer readable program code contains information selected from the group consisting of:
personal information;
emergency contact information;
or primary care physician information.

9. The medical information system as in claim 1, wherein said non-circular shaped compact disk contains a picture of a user disposed on a front face of said disk.

10. The medical information system as in claim 8, further comprising a medical information sheet disposed within said plastic sheath wherein said medical information sheet contains printed information relating to the user's name and address.

11. A process for creating a medical information card comprising the steps of:
presenting an application for a medical information card over a communication network;
receiving medical and personal information from a user over said communication network;
copying said information to a compact disk; and
mailing said compact disk to said user.

12. The process as in claim 11, further comprising the step of inserting said compact disk into a protective plastic sheath.

13. The process as in claim 12, further comprising the step of inserting a medical information sheet into said protective plastic sheath wherein said medical information sheet is disposed adjacent to said medical information card.

14. The process as in claim 11, further comprising the step of requesting a digital picture from a user and receiving said digital picture from said user over said communication network.

15. The process as in claim 14, further comprising the step of recording said digital picture onto said compact disk.

16. The process as in claim 14, further comprising the step of printing said digital picture onto said medical information sheet.

17. A process for creating a medical information card comprising the steps of:
a) presenting a medical information application;
b) receiving medical information from a user;
c) transposing said medical information from said user into a computer;
d) copying said medical information onto a miniature compact disk; and
e) presenting said user with a miniature compact disk having the user's medical information including medical history on said miniature compact disk.
